(19) United States
(12) Patent Application Publication
(10) Pub. No.: US 2021/0274863 A1
(43) Pub. Date: Sep. 9, 2021

(54) Strapless Mask

(71) Applicant: Ryan Ram, Hempstead, NY (US)

(72) Inventor: Ryan Ram, Hempstead, NY (US)

(21) Appl. No.: 17/118,744

(22) Filed: Dec. 11, 2020

(51) Int. Cl. A41D 13/11; A62B 23/02; A41D 31/04

(52) U.S. Cl. CPC A41D 13/1161; A41D 31/04; A41D 13/1115; A62B 23/025

(57) ABSTRACT

The Strapless Mask assembly which serves as a personal protection equipment that protects against airborne diseases and viruses includes two parts, A fabric covering which incorporates pockets that covers the nose and the mouth which will holds a HEPA filter that provides extra respiratory protection, and a supporting concave curved frame that fits on the cheek bones, resting on the ridge of the nose and uses the jaw lining to secure itself in place referred to as the structural component. The frame member includes a downwardly extending projection in front of the ear. The fabric covering has a slot sewn along the top of the material which extends downward along each side of the covering. The double layer fabric sewn together allows for the frame to be inserted in the covering from the center of the mask.

### FIELD OF THE INVENTION

The present invention relates to the personal protection equipment mask for various members of the labor force including medical personnel, construction workers and the general public, and more particularly to a mask that requires no straps i.e., “Strapless Mask.”

### BACKGROUND OF THE INVENTION

In the medical industry the use of the face mask covering is a mandatory as it protects its users and patients from air born infections and diseases and in the recent COVID pandemic protecting one's self and others has allowed the mask to become of mandatory use. Although such devices are available, they are constructed to be used with a support mechanism namely ties, straps, loops or adhesive which allows for the formation of rashes, swelling, and discomfort to users in various labor force and the general public.

### SUMMARY

The Strapless Mask assembly for protecting the face of the user include two parts; A fabric covering which incorporates pockets that covers the nose and the mouth which will store a HEPA filter that provides extra respiratory protection, and a supporting concave curved frame would fit on the cheek bones, resting on the ridge of the nose and uses the jaw lining to secure itself in place.

The frame member may include a downwardly extending projection in front of the ear. The fabric covering has a slot sewn along the top of the material which extends downward along each side of the covering. The double layer fabric sewn together allows for the frame to be inserted in the covering from the center of the mask.

The Concave ‘C’ shaped frame with downward extending projections is made using either plastic, aluminum, copper, metal, or galvanized steel which is molded into the concave shape.

The fabric cover has an additional slot sewn onto the inner fabric which allow a bendable strip of metal to allow mask to press firmly on top of the ridge of the nose which allows for a secured and comfortable fit and an air-tight seal against the face.

The inner layer of the fabric covering has a pocket that hold a HEPA filter that is sewn in place to protect the nose and mouth.

The fabric covering carries two eyelets one on each corner of the top of the fabric which allows for straps to be added if desired.

The fabric covering could be produced in a manner similar to that of a conventional face mask and incorporate comparable production procedures. Basic materials that could be used includes polyester and cotton among other suitable fabrics.

The strapless mask can be produced in various sizes ranging from Extra-Small (XS), Small (S), Medium (M), Large (L) and Extra-Large (XL).

The Fabric covering is sewn with an extra length downwards to be worn by individuals with long beards.

The mask covering fabric may include a first surface of camouflage indicia and it includes a second surface including indicia.

The fabric covering can be sewn using multiple stitching styles and patterns.

### DETAILED DESCRIPTION

FIG. 1 Illustrates a top view of the frame member of the present invention which is approximately C or Concave shaped.

FIG. 2 illustrates the material used to make frame member of the present invention.

FIG. 3 illustrates a cap which is used to act as a firm grip at the end of the frame.

FIG. 4 illustrates a top view of the frame member of the present invention.

FIG. 5 illustrates a bottom view of the frame member of the present invention.

FIG. 6 illustrates a front view of the frame member of the present invention.

FIG. 7: Illustrates a right-side view of the frame member of the present invention.

FIG. 8: Illustrates a left-side view of the frame member of the present invention.

FIG. 9: Illustrates a variation of frame member. This variation is extended along the jawbone in a U shaped along the parameters of the users' entire jaw structure.

FIG. 10: Illustrates a right sideview of frame member.

FIG. 11: Illustrates a 2^{nd} variation design of the original frame member.

FIG. 12: Illustrates a right sideview of the 2^{nd} variation of the original frame member.

FIG. 13: Illustrates a 3^{rd} variation design of frame member.

FIG. 14: Illustrates a right sideview of the 3^{rd} variation design of the mask frame.

FIG. 15: Illustrates a 4th variation design of the original frame member.

FIG. 16: Illustrates a right sideview of the 4^{th} variation design frame member.

FIG. 17: Illustrates a 5^{th} variation design of the original frame member.

FIG. 18: Illustrates a right sideview of the 5^{th} variation design of the original frame member.

FIG. 19: Illustrates a 6^{th} variation design of the original frame member.

FIG. 20: Illustrates a right sideview of the 6^{th} variation design of frame member.

FIG. 21: Illustrates a perspective view of the fabric covering being worn with the eyelets.

FIG. 22. Illustrates a cross-section view of the eyelets.

FIG. 23. Illustrates left-side view of the mask member 100.

FIG. 24. Illustrates the fabric cover 100 with the sewn in slot 100 and the frame member 5 inserted into the slot.

FIG. 25: Illustrates a closer view of the metal strip 42 which goes over the nose.

FIG. 26: Illustrates a cross-sectional view of the sewn slot 101.

FIG. 27: Illustrates a view of the inside of the fabric covering 100.

FIG. 28: Illustrates a 3 D view of the HEPA Filter 132 in place at the center of the fabric covering 100.

FIG. 29: Illustrates the assembled strapless mask 100 being worn by user 46.

FIG. 30: Illustrates a right-side view of the strapless mask 100.

FIG. 31: Illustrates a 1st variation of the mask fabric covering. This Variation of the mask covering is the basic model sewn with a curved bottom

FIG. 32: Illustrates a right-side view of the solid color fabric mask covering 2^{nd} variation.

FIG. 33: Illustrates a left-side view of the solid color fabric mask covering 2^{nd} variation.

FIG. 34: Illustrates a 2^{nd} variation of the fabric cover for the Strapless Face mask appealing to users with long beard.

FIG. 35: Illustrates the long variation of the fabric covering and how it looks and covering the users face and beard entirely.

FIG. 36: Illustrates a right-side view of the fabric covering. It shows the curvature of the fabric cover that aligns with the users' face.

FIG. 37: Illustrates a 3^{rd} variation of the fabric mask covering. This fabric covering is sewn with pleats from side to side of the mask.

FIG. 38: Illustrates a right sided view of the pleated fabric covering, 3^{rd} variation.

FIG. 39: Illustrates a Left-sided view of the pleated fabric covering, 3^{rd} variation.

FIG. 40: Illustrates 4^{th} variation of the fabric mask covering. This variation is sewn in the shape of the bottom have of ones' face and has pointed shape going outwards from the mouth.

FIG. 41: Illustrates a right -sided view of the mask covering that creates a space between the fabric and mouth, 4^{th} variation.

Fabric 42: Illustrates a left-sided view of the mask covering that creates a space between the fabric and the mouth, 4^{th} variation.

### BRIEF DESCRIPTION OF THE DRAWINGS

FIG. 1 Illustrates a top view of the frame member 5 of the present invention which is approximately C or Concave shaped. The frame member 5 consist of U-shaped portion 25 that sits on the bridge of the nose extending downwards to the base of the nose and connects to portion 15 which rest below the eye socket and ends at the end of the cheek bone. A slightly curved portion 10 allows the frame member 5 to sit firmly on the users face and connects portion 15 to portion 30 which extends downward along the jaw line of the user. Portion 30 is covered with a soft plastic cap 20 which allows for a firm and comfortable grip along the jawline.

FIG. 2 illustrates the material used to make frame member 5 of the present invention. The molded frame member 5 can be made using a variety of materials including plastic, aluminum, copper, metal, or Galvanized steel.

FIG. 3 illustrates portion 20 a cap which is used to act as a firm grip at the end of the frame member 5 and create a smooth and comfortable finish. Portion 20 can be made using plastic and/or rubber.

FIG. 4 illustrates a top view of the frame member 5 of the present invention in its ready to use form.

FIG. 5 illustrates a bottom view of the frame member 5 of the present invention fully invention in its ready to use form.

FIG. 6 illustrates a front view of the frame member 5 of the present invention in its ready to use form.

FIG. 7: Illustrates a right-side view of the frame member 5 of the present invention in its ready to use form.

FIG. 8: Illustrates a left-side view of the frame member 5 of the present invention in its ready to use form.

FIG. 9: Illustrates a variation of frame member 5. This variation 60 is extended along the jawbone in a U shaped along the parameters of the users' entire jaw structure. Portion 61 illustrates the additional U-shaped frame that is added onto frame member 5 to for variation 60.

FIG. 10: Illustrates a right sideview of frame member 60. This right-side view shows the cross section of the frame member.

FIG. 11: Illustrates a variation of the frame member 5. Variation 70 extends to the side of the face and turns at a 90 Degree angle and extends 1″ past the jaw line by portion 71.

FIG. 12: Illustrates a right sideview of frame member 70. This right-side view shows the cross section of the frame member.

FIG. 13: Illustrates a variation of frame member 5. This variation 80 is shaped to hook on the cheek bone solely in a reverse c Shape pattern. This frame member has a higher arch 82 and a deep curve under the eye socket 81.

FIG. 14: Illustrates a right sideview of frame member 80. This right-side view shows the cross section of the frame member.

FIG. 15: Illustrates a variation of Frame member 5. This variation 90 is designed to sit along the eye socket which is showed in section 91 and extends downwards in a U-shaped pattern to allow for easy use with safety goggles and/or large eyeglasses.

FIG. 16: Illustrates a right sideview of frame member 90. This right-side view shows the cross section of the frame member.

FIG. 17: Illustrates a variation of frame member 5. This variation 110 allows the frame to rest on the top of the head midsection as a form of support for the strapless mask fabric covering. This variation 110 is designs to for individuals with deformities that cannot support the initial frame member 5. Portion 111 illustrates the frame going upwards.

FIG. 18: Illustrates a right sideview of frame member 110. This right-side view shows the cross section of the frame member.

FIG. 19: Illustrates a variation of frame member 5. This variation 120 is a combination of variation 60 with an additional T Shaped pattern that extends vertically 21 and horizontally 23 across the mouth area to prevent the fabric covering from touching the lips.

FIG. 20: Illustrates a right sideview of frame member 120. This right-side view shows the cross section of the frame member.

FIG. 21: 40 Illustrates a perspective view of the fabric covering 100 being worn with the eyelets 41 in the top corner of each side. Portion 41 give the user an option to add straps for additional support if desired. In the center of the fabric 100, a flexible strip of metal 42 is sewn over the nostril area. This portion 42 allows the user to press the mask firmly to the nostrils which creates a skintight air seal and also adds to the support of the mask.

FIG. 22. Illustrates a cross-section view of the eyelets, Portion 41.

FIG. 23. Illustrates left-side view of the mask member 100. Portion 101 is the sewn slot which house frame member portion 5. Portion 41 shows the eyelet.

FIG. 24. Illustrates the fabric cover 100 with the sewn in slot 100 and the frame member 5 inserted into the slot. Portion 101 keeps the frame member 5 in place and secured on the users' face.

FIG. 25: Illustrates a closer view of the metal strip 42 which goes over the nose and presses firmly to create a secured air-tight feel.

FIG. 26: Illustrates a cross-sectional view of the sewn slot 101 and the frame member section 30 when its inserted in the slot.

FIG. 27: Illustrates a view of the inside of the fabric covering 100. The fabric covering has two layers which holds 132 a HEPA Filter over the nose and mouth area. The HEPA Filter 132 is inserted into the center of the mask through opening slots 133 sewn 1 inch from the end of the fabric covering on the inside. Portion 134 is the opening used to insert the frame member 5 into the sewn slot 101.

FIG. 28: Illustrates a 3 D view of the HEPA Filter 132 in place at the center of the fabric covering 100.

FIG. 29: Illustrates the assembled strapless mask 100 being worn by user 46. Portion 42 allows the user to secure the mask to the nose. Portion 41 illustrates the eyelet for additional support strap.

FIG. 30: Illustrates a right-side view of the strapless mask 100. This view shows the curvature of the corners of the strapless mask that lines up the users' face.

FIG. 31: Illustrates a front view of the 1st variation of the mask fabric covering. This Variation of the mask covering is the basic model sewn with a curved bottom with camouflage indicia. Portion 400 is an air vent incorporated into covering 100 which can be located on either or both side of the fabric covering.

FIG. 32: Illustrates a right-side view of the solid color fabric mask covering. It gives a closer view of the air vent in place and the bottom of the mask.

FIG. 33: Illustrates a left-side view of the solid color fabric mask covering.

FIG. 34: Illustrates a 2nd variation of the fabric cover for the Strapless Face mask appealing to users with long beard, this outline 315 of the fabric covering 300 is sewn with an extended bottom that covers the entire beard of the user. This Fabric cover utilizes the same frame mask member 5 which support and holds it in place on the users' face.

FIG. 35: Illustrates the long variation of the fabric covering and how it looks covering 315 the users face and beard. This Fabric cover utilizes the same frame mask member 5 which support and holds it in place on the users' face.

FIG. 36: Illustrates a right-side view of the fabric covering 315. It shows the curvature of the fabric cover that aligns with the users' face.

FIG. 37: Illustrates a 3^{rd} variation of the fabric mask covering. This fabric covering is sewn with pleats 330 from side to side of the mask. These pleats allow the mask to be extended downward to the bottom of the face. This feature benefits all users as it can be adjusted to extend to suit all face shapes and sizes.

FIG. 38: Illustrates a right sided view of the pleated fabric covering.

FIG. 39: Illustrates a Left-sided view of the pleated fabric covering.

FIG. 40: Illustrates a 4^{th} variation of the fabric mask covering. This variation is sewn in the shape of the bottom half of ones' face and has Y shaped 340 sewing extending outwards from the mouth. This creates a space between the fabric and the mouth of the user.

FIG. 41: Illustrates a right -sided view of the mask covering that creates a space between the fabric and mouth.

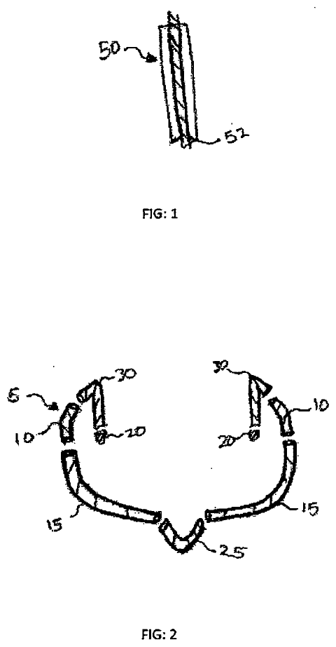

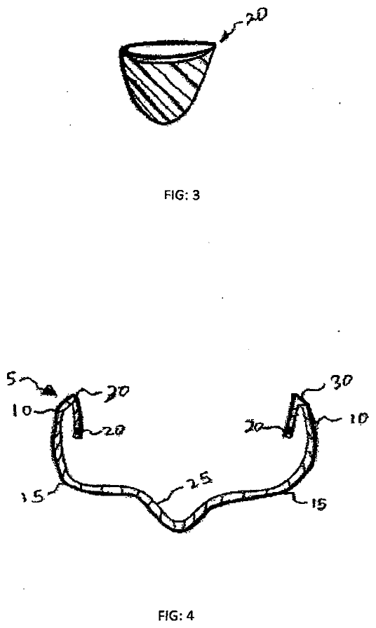

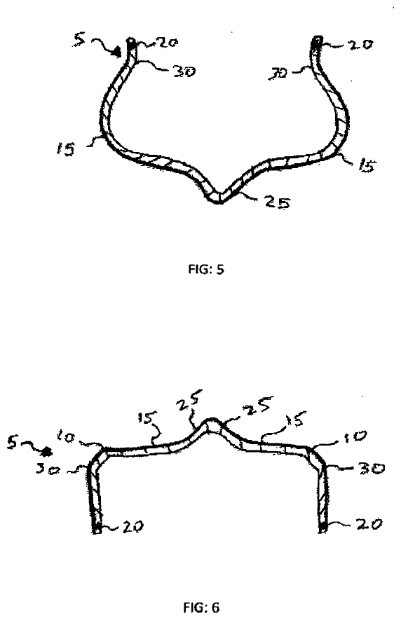

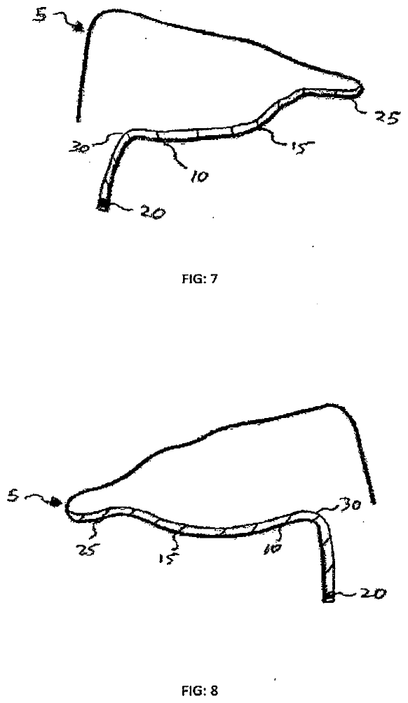

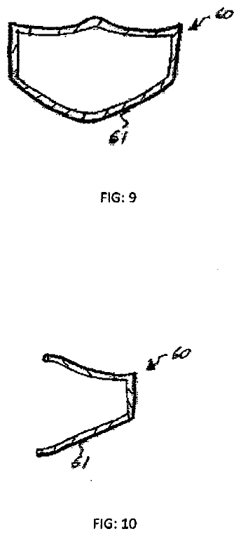

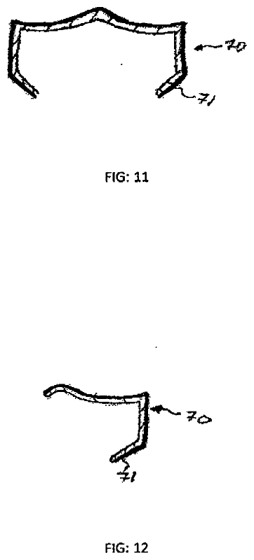

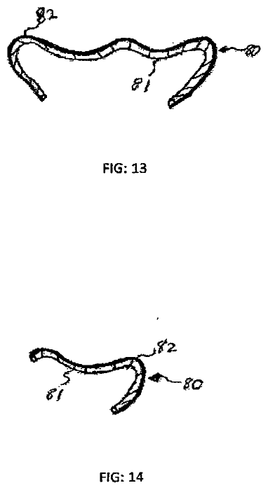

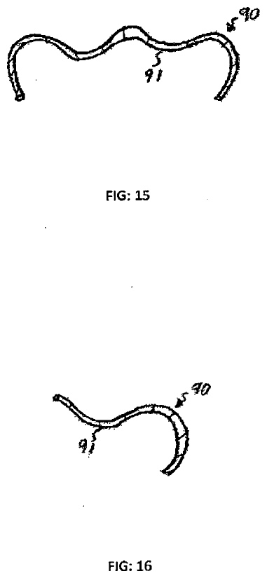

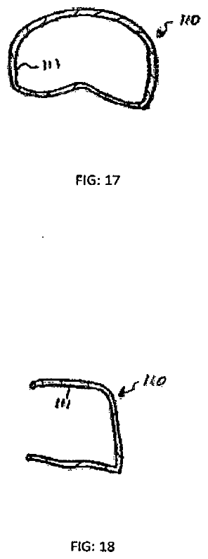

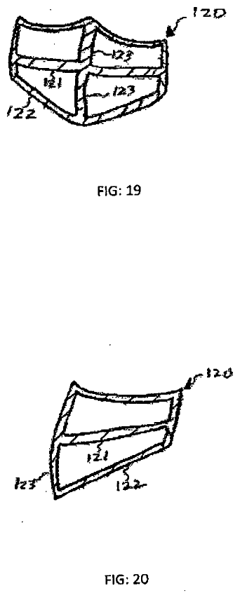

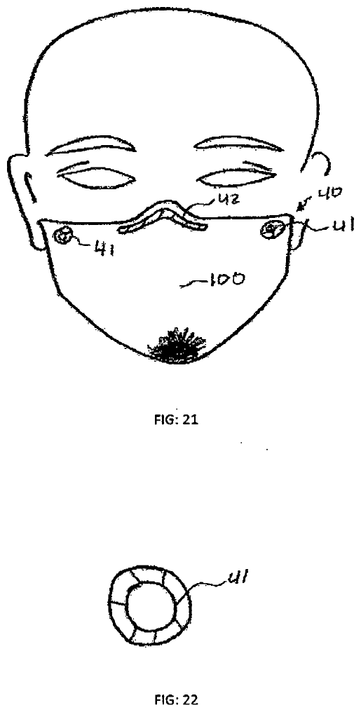

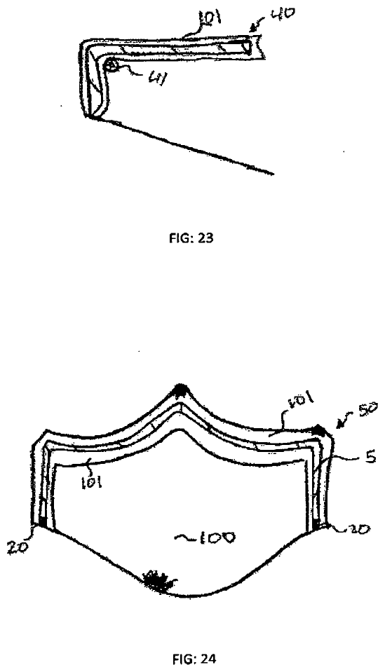

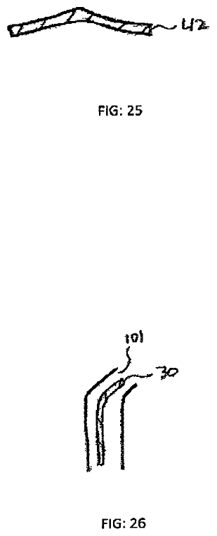

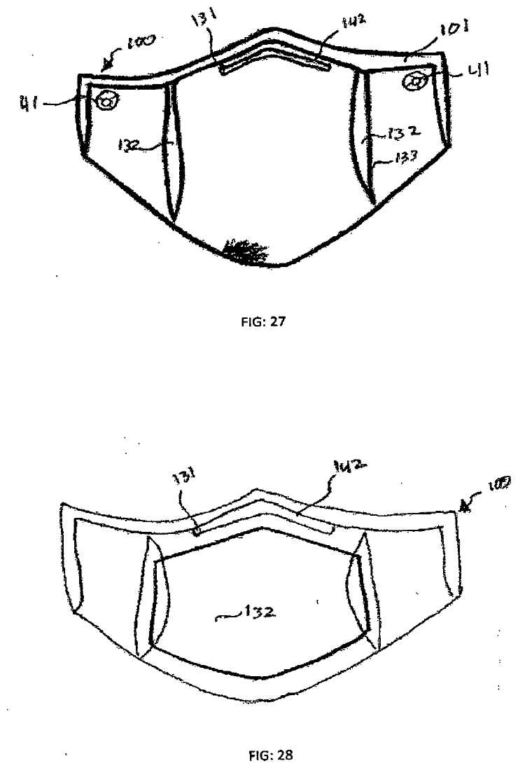

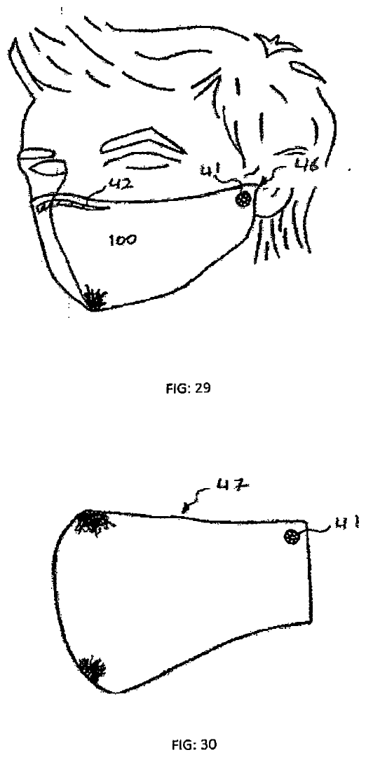

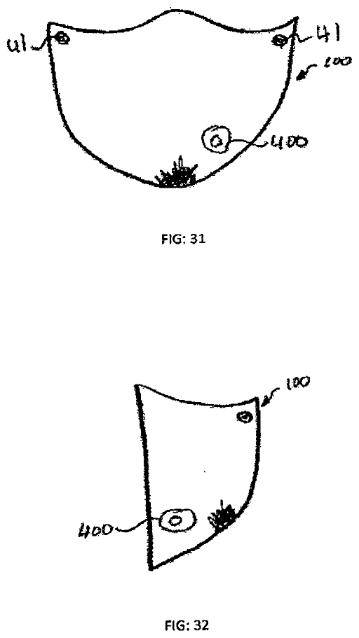

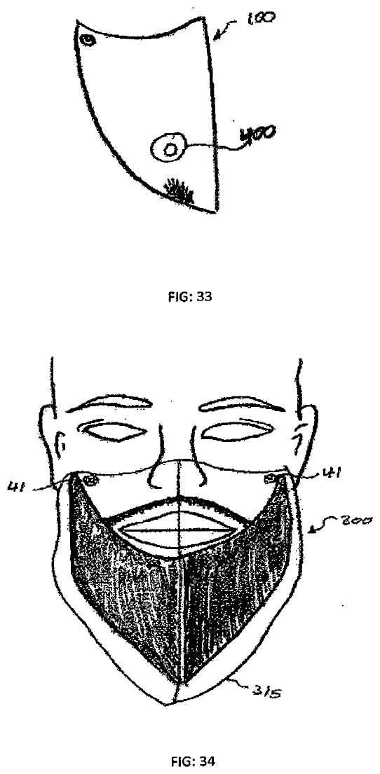

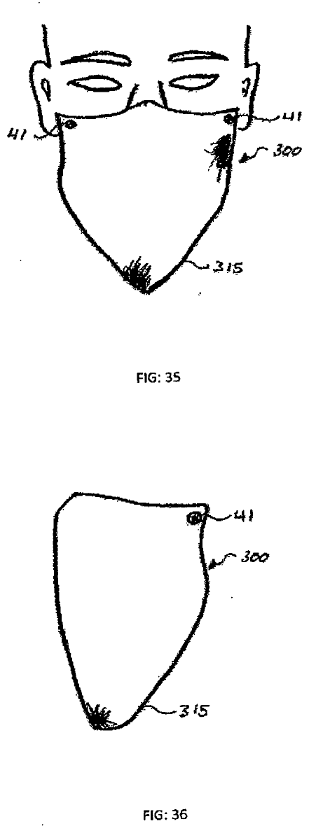

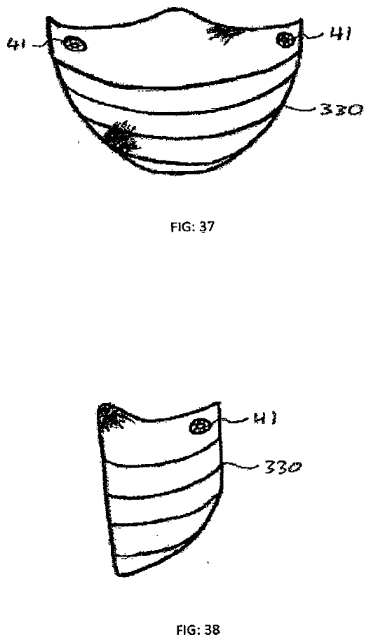

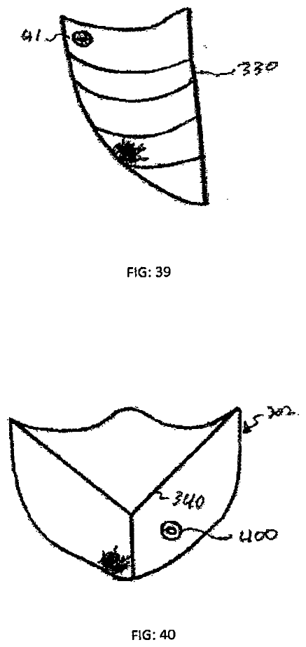

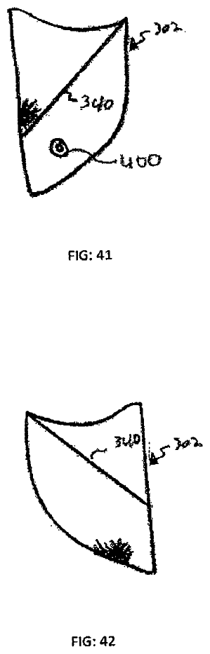

Fabric 42: Illustrates a left- sided view of the mask covering that creates a space between the fabric and the mouth.

What is claimed is:

1. A strapless mask which serves as a personal protection equipment for protecting its users from airborne diseases and viruses comprising:
A fabric covering with a HEPA Filter with a sewn slot at the top of the fabric,
Wherein a frame member is inserted into the sewn slot which hold the mask in position on the users' face.
Wherein a metal strip in sewn in along the top of the nose,
Wherein eyelets are added to top of each side combined to keep the mask in position covering the nose and mouth of the user.

2. A Strapless mask which serves as a personal protection equipment as in claim 1, where the frame member is designed in a concave curved C shape designed to sit on the cheek bones of the user.

3. A Strapless mask which serves as a personal protection equipment as in claim 1, where the frame member is designed to extend along the jawbone in a U shaped along the parameters of the users' entire jaw structure.

4. A Strapless mask which serves as a personal protection equipment as in claim 1, Where the frame member extends to the side of the face and turns at a 90 Degree angle and extends 1″ past the jaw line.

5. A strapless mask which serves as a personal protection equipment as claim 1, where the frame is shaped to hook on the cheek bone solely in a reverse c Shape pattern. This frame member has a higher arch and a deep curve under the eye socket.

6. A strapless mask which serves as a personal protection equipment as claim 1, where the frame member is designed to sit along the eye socket and extends downwards in a U-shaped pattern to allow for easy use with safety goggles and/or large eyeglasses.

7. A strapless mask which serves as a personal protection equipment as claim 1, where the frame member is designed to rest on the top of the midsection of the users head as a form of support for the strapless mask fabric covering. This variation is designed to for individuals with deformities that cannot support the initial frame member as stated in claim 2.

8. A strapless mask which serves as a personal protection equipment as claim 1, where the frame member is designed as with a combination of claim 3 with an additional T Shaped pattern frame that extends vertically and horizontally across the mouth area to prevent the fabric covering from touching the lips of the user.

9. A strapless mask which serves as a personal protection equipment as claim 1, where the frame member is inserted into a fabric covering which goes over the nose and mouth of the user. The fabric covering, which includes camouflage indicia, has two layers which holds a HEPA Filter over the nose and mouth area in place. This Variation of the mask covering is the basic model sewn with a curved bottom. It has a solid color and will carry an air vent on the bottom of either or one side of the fabric.

10. A strapless mask which serves as a personal protection equipment where the frame member is inserted into a fabric covering as in claims 1 and 2, where the fabric covering is designed to appeal to users with long beard where fabric covering is sewn with an extended bottom that covers the entire beard of the user with a V or U-shaped curve in the bottom.

11. A strapless mask which serves as a personal protection equipment where the frame member is inserted into a fabric covering as in claims 1 and 2, wherein the fabric covering is sewn with pleats from side to side of the mask. These pleats allow the mask to be extended downward to the bottom of the face. This feature benefits all users as it can be adjusted to extend to suit all face shapes.

12. A strapless mask which serves as a personal protection equipment where the frame member is inserted into a fabric covering as in claims 1 and 2, where the fabric covering is sewn in the shape of the bottom half of ones' face and has Y shaped sewing extending outwards from the mouth. This creates a space between the fabric and the mouth of the user.

13. A strapless mask which serves as a personal protection equipment as in claims 1 and 2 where a HEPA Filter is inserted into the center of the mask through opening slots sewn 1 inch from the end of the fabric covering on the inside.

14. A strapless mask which serves as a personal protection equipment as in claims 1 and 2 where a bendable metal strip is inserted into sewn slot above the nose. This allows the user to firmly press the mask up against the nose and creates an air-tight seal and added support.

15. A strapless mask which serves as a personal protection equipment as in claims 1 and 2 where then fabric covering has eyelets on the top end of each side of the covering. This serves as means to add straps to each end of the mask and tie behind the head for added support as desired.

16. A strapless mask which serves as a personal protection equipment as in claims 1 and 2 where an air vent is installed on the right bottom side of the fabric covering. This allows users to choose to let air in without having to remove the mask from the face.

17. A strapless mask which serves as a personal protection equipment as in claims 1 and 2 where a rubber/plastic cap is placed on the ends of the frames for a smooth finish.

18. A strapless mask which serves as a personal protection equipment as in claim 1, where the any 1 frame member can be inserted into any 1 fabric covering.

19. A strapless mask which serves as a personal protection equipment as in claims 1, where the type of fabric, colors, pattern, texture, and overall indicia varies as per demand.

20. A strapless mask which serves as a personal protection equipment as in claims 1 and 2 where the application method for the strapless mask begins by holding the mask in front of the nose and mouth, firmly grip both ends of the mask with the index finger and thumb, placing the covering over the mouth and nose with the top 90 Degree corners positioned in front of the tragus of the ears, with the downward extending sides resting just under the earlobe over the base of the jawline, then firmly squeeze the bendable metal strip against the ridge of the nose creating a secured fit.
